(19) United States
(12) Patent Application Publication
(10) Pub. No.: US 2017/0344912 A1
(43) Pub. Date: Nov. 30, 2017

(54) TRAVEL BOOKING SYSTEM AND METHOD

(71) Applicant: Tamsin MAGNAY, Chermside West (AU)

(72) Inventor: Tamsin MAGNAY, Chermside West (AU)

(21) Appl. No.: 15/260,720

(22) Filed: Sep. 9, 2016

(30) Foreign Application Priority Data
May 30, 2016 (AU) 2016203580

(51) Int. Cl. G06Q 10/02; G06F 3/0486; G06F 3/0482

(52) U.S. Cl. CPC G06Q 10/025; G06F 3/0482; G06F 3/0486

(57) ABSTRACT

A travel booking system, a travel booking method, and a method for booking a package holiday comprising a plurality of holiday components is provided. The method for booking the package holiday comprises: receiving a selection of a first holiday component; selecting one or more of a plurality of second holiday components according to an availability of the second holiday components and a compatibility with the first holiday component; and providing, the one or more second holiday components for selection by the user.

### TECHNICAL FIELD

The present invention relates to the booking of travel. In particular, although not exclusively, the invention relates to the booking of package holidays.

### BACKGROUND ART

It is generally well established that booking travel and tours can be complex, particularly when multiple products or services are combined. In particular, the booking of travel may include the booking of flights, a tour, tickets to attractions, ground transport, transfers, cruises, visas and hotels, all of which must be coordinated.

In certain cases, package holidays are provided, where flights, hotels and the like are coordinated and sold to passengers as a package. The advantage of such packages is that flights, hotels, and the like may be coordinated and booked in blocks, rather than for each individual traveller. A problem with such package holidays, however, is that they generally provide little flexibility.

As such, travel agents are often utilised to assist in booking customised holidays, where flights, tours, accommodation and the like are customised to the customer's preferences. This requires significant planning on behalf of the travel agent, as it requires the travel agent to manually coordinate each element of the trip.

A problem with customised holidays is that many combinations of flights, tours, accommodation and the like may be unavailable, and printed material, such as brochures, are unable to show availability of associated travel products. For example, a particular tour may be fully booked, preventing a holiday including that tour from being booked. In such case, the customer may choose to consider other dates, or other tours.

In order to make sales, travel agents must generally discuss tours and example holidays with customers, prior to knowing when the customer is willing to travel and specific availability at that time. It becomes difficult for the travel agent to make a sale when a product (such as a tour) is discussed or suggested, and it is later found out that it is not available the required dates. In many cases, the client may leave the travel agent disappointed, and without making a booking.

As such, the travel agent may lose out on the sale (and thus commission), despite having spent significant time with the customer.

A further problem with customised holidays is that it is very time consuming for customers to go through brochures and itineraries manually, particularly if multiple tours from different providers are considered and compared. In some cases, the process can also be overwhelming for the customer.

As such, there is clearly a need for an improved travel booking system.

It will be clearly understood that, if a prior art publication is referred to herein, this reference does not constitute an admission that the publication forms part of the common general knowledge in the art in Australia or in any other country.

### SUMMARY OF INVENTION

The present invention is directed to travel booking systems and methods, which may at least partially overcome at least one of the abovementioned disadvantages or provide the consumer with a useful or commercial choice.

With the foregoing in view, the present invention in one form, resides broadly in a method for booking a package holiday comprising a plurality of holiday components, the method comprising:

receiving a selection of a first holiday component;

selecting one or more of a plurality of second holiday components according to an availability of the second holiday components and a compatibility with the first holiday component; and

providing, the one or more second holiday components for selection by the user.

Advantageously, the method simplifies the process of booking a package holiday by providing targeted holiday components according to their availability and compatibility with other holiday components. For example, unavailable holiday components, such as cruises, need not even be shown to the user, nor components that are incompatible with other components, such as overlapping tours.

Preferably, the first holiday component relates to a different category of holiday component to the second holiday components. The categories may include flights, insurance, car hire, accommodation, cruises, river cruises, coach tours, day trips, transfers, visas and currency exchange.

The method may comprise determining an availability of each of a plurality of second holiday components.

The first holiday component may be associated with a first time period, and the second holiday component may be associated with a second time period. Compatibility with the first holiday component may comprise determining that the first and second time periods do not overlap. This is particularly advantageous when the first and second holiday components are tours, where it is not possible to take part in both tours simultaneously.

The selection of the first holiday component may comprise a selection by the user.

The one or more second holiday components may be selected in part according to demographics of one or more travellers. The demographics may include age.

The holiday components may be selected in part according to demographics of a group of travellers. The demographics may include a group composition. An example of a group composition is a combination of adult and children forming a family.

According to certain embodiments, prices are generated according to the demographics. For example, a 0-2 year old child may be eligible for infant pricing on flights (e.g. only 10% of the price of a full fare), a 2-11 year old child may be eligible for child pricing (e.g. 75% of the price of a full fare), and a 12+ year old child may require adult pricing for flights.

According to certain embodiments, the demographics of the group are used to determine if a family meets family discount criteria. For example, certain hotels allow children to stay and eat free under certain conditions, and the demographics of the group may be used to determine whether these conditions are met.

Profiles of travellers may be generated, and stored for later use. For example, profiles may be used in relation to later holidays and itineraries, without requiring the user to enter all details again.

The method may comprise receiving demographic information from the travellers.

The method may comprise receiving a selection of cities or countries, where the holiday components are selected in part according to the selected cities or countries.

The method may further comprise: receiving start and end times of the package holiday; and determining an availability of the plurality of second holiday components at least in part according to the start and end times. This is particularly advantageous as the holiday component (such as a tour) may be available outside of the traveller's holiday, which has little relevance to the traveller.

The method may further comprise, entering, into a digital calendar, details of the first holiday component. The second holiday component may be selected with reference to the calendar, and subsequently entered into the digital calendar. The digital calendar may be displayed to the user. The first and second holiday components may be graphically distinguishable in the calendar. For example, the first and second holiday components may be colour coded in the digital calendar.

The holiday components may be selected by dragging the component onto the calendar with a drag and drop system. The calendar may allow to holiday component to be dragged onto different positions in the calendar, the different positions relating to different time periods for the holiday component. As such, the user may not only select the holiday component, but also a configuration (e.g. a timing) of the holiday component.

The calendar may be configured to prevent the holiday component from being dragged onto non-available position. For example, if a tour is selected from the 15^{th} to 30^{th} of June, then the system will not allow the booking of a day trip on the 19^{th} of June as the user is already engaged on that day.

The calendar may be defined in memory, where each day is associated with an attribute indicating an availability of that day. The attribute may comprise a flag, indicating either “available” or “unavailable”. Alternatively, the attribute may define a compatibility with holiday components. For example, the attribute may indicate that a hotel may be compatible with a tour that has been booked on a particular day, but not another tour.

A plurality of attributes may be associated with each day. For example, the day may be split into several portions (e.g. morning, afternoon and evening). Alternatively or additionally, attributes may be present for each of a plurality of categories. The categories may include flights, insurance, car hire, accommodation, cruises, river cruises, coach tours, day trips.

The method may comprise providing a graphical user interface to the user, the graphical using interface including the calendar. The graphical user interface may be provided by a web server.

The method may comprise receiving payment, and booking the holiday components with associated component providers. The payment may comprise a deposit or full payment for the holiday. The payment may comprise a fee for making a booking.

The method may comprise illustrating at least one of the second holiday components according to a map.

The method may include generating an itinerary, including the holiday components.

In another form, the invention resides broadly in a method for booking travel comprising a plurality of travel components, the method comprising:

receiving a selection of a first travel component;

selecting one or more of a plurality of second travel components according to an availability of the second travel components and a compatibility with the first travel component; and

providing, the one or more second travel components for selection by the user.

In yet another form, the invention resides broadly in a travel booking system, for booking travel comprising a plurality of travel components, the system comprising:

a selection module, for selecting one or more of a plurality of second travel components according to an availability of the second travel components and a compatibility with a first travel component; and

a data interface, for receiving a selection of a first travel component, and providing the one or more second travel components for selection by the user.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a travel booking system, according to an embodiment of the present invention;

FIG. 2 illustrates a screenshot of a trip name screen of the system of FIG. 1, according to an embodiment of the present invention;

FIG. 3 illustrates a screenshot of a passenger details screen of the system of FIG. 1, according to an embodiment of the present invention;

FIG. 4 illustrates a screenshot of a trip details screen of the system of FIG. 1, according to an embodiment of the present invention;

FIG. 5 illustrates a screenshot of a trip creation screen of the system of FIG. 1, according to an embodiment of the present invention;

FIG. 6 illustrates a screenshot of a tour selection screen of the system of Figure according to an embodiment of the present invention;

FIG. 7 illustrates a screenshot of a tour detail screen of the system of FIG. 1, according to an embodiment of the present invention;

FIG. 8 illustrates a further screenshot of the trip creation screen of the system of FIG. 1, according to an embodiment of the present invention;

FIG. 9 illustrates a screenshot of a flight details screen of the system of FIG. 1, according to an embodiment of the present invention;

FIG. 10 illustrates a screenshot of a flights results screen of the system of Figure according to an embodiment of the present invention;

FIG. 11 illustrates a further screenshot of the trip creation screen of the system of FIG. 1, according to an embodiment of the present invention;

FIG. 12 illustrates a screenshot of a trip summary screen of the system of FIG. 1, according to an embodiment of the present invention;

FIG. 13 illustrates a schematic of a server of the system of FIG. 1, according to an embodiment of the present invention; and

FIG. 14 illustrates a travel booking method, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

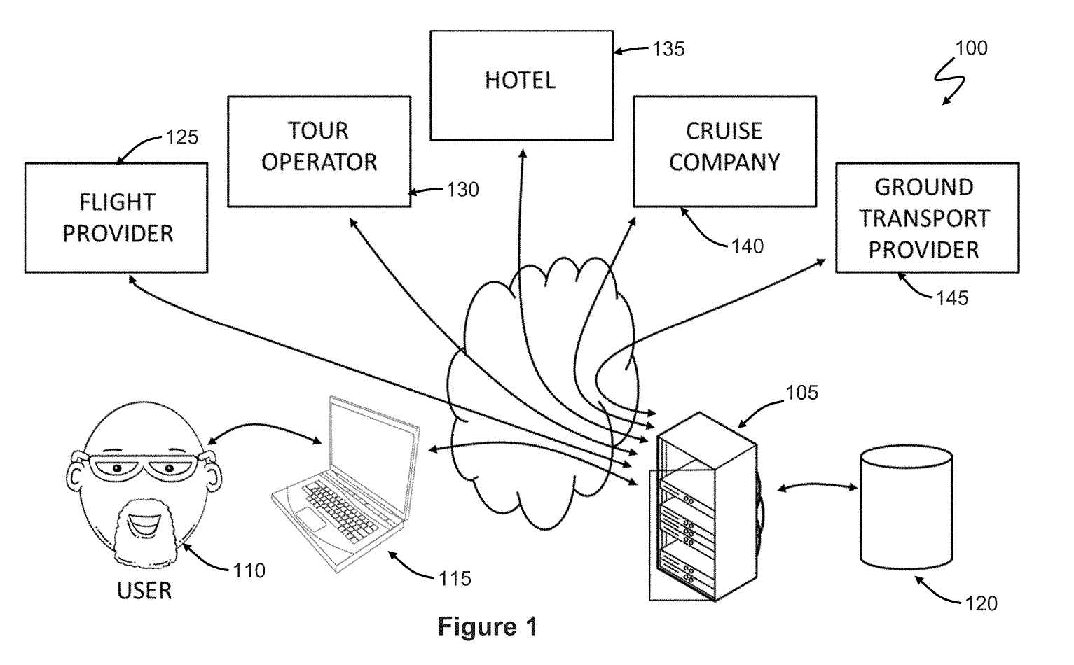

FIG. 1 illustrates a travel booking system 100, according to an embodiment of the present invention. The system 100 allows customers to book multiple components of a trip, such as flights, insurance, car hire, accommodation, cruises, river cruises, coach tours, day trips, and currency exchange, from a single, easy to use interface. The system 100 is particularly suited to booking a package holiday.

As described in further detail below, the user interface is based upon a calendar illustrating available travel days, and preventing the booking of incompatible or unavailable components. In particular, trip components are filtered such that only those that are suitable or available are shown. The filtered components can then be inserted into the calendar by the user, upon which the activity is entered into an itinerary for the user. The system 100 enables assisted selection of travel components, and prevents overlap of activities (where such overlap is not possible).

The system 100 includes a travel booking server 105, with which a user 110 interacts using a computing device 115. In particular, the travel booking server 105 may include a web server, which is configured to provide a graphical user interface to the computing device in the form of a web page.

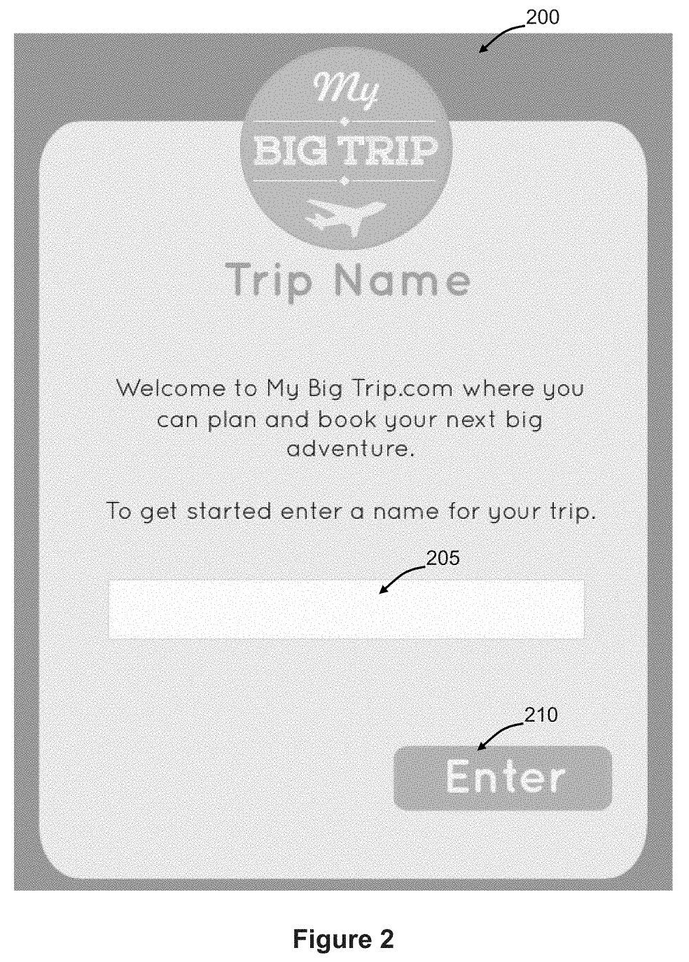

Initially, the user interface prompts the user 110 to enter a name of the trip in a trip name screen. FIG. 2 illustrates a screenshot 200 of a trip name screen of the system 100, according to an embodiment of the present invention.

The trip name screen includes a trip name entry field 205, in which the user is able to enter a name of the trip, such as “Europe Trip 2.0”. The name of the trip can be used to distinguish between multiple trips, which is particularly advantageous if the user 110 is entering and comparing multiple trips.

Details of the trip, including partial details as they are being entered, are saved on a data store 120. The name of the trip may then be used to retrieve a particular trip later, from the data store, for example to complete details of the trip if only partially completed, or to pay for all or part of the trip at a later point in time.

Once the user enters the name of the trip, an “enter” button 210 may be selected to navigate to a passenger details screen.

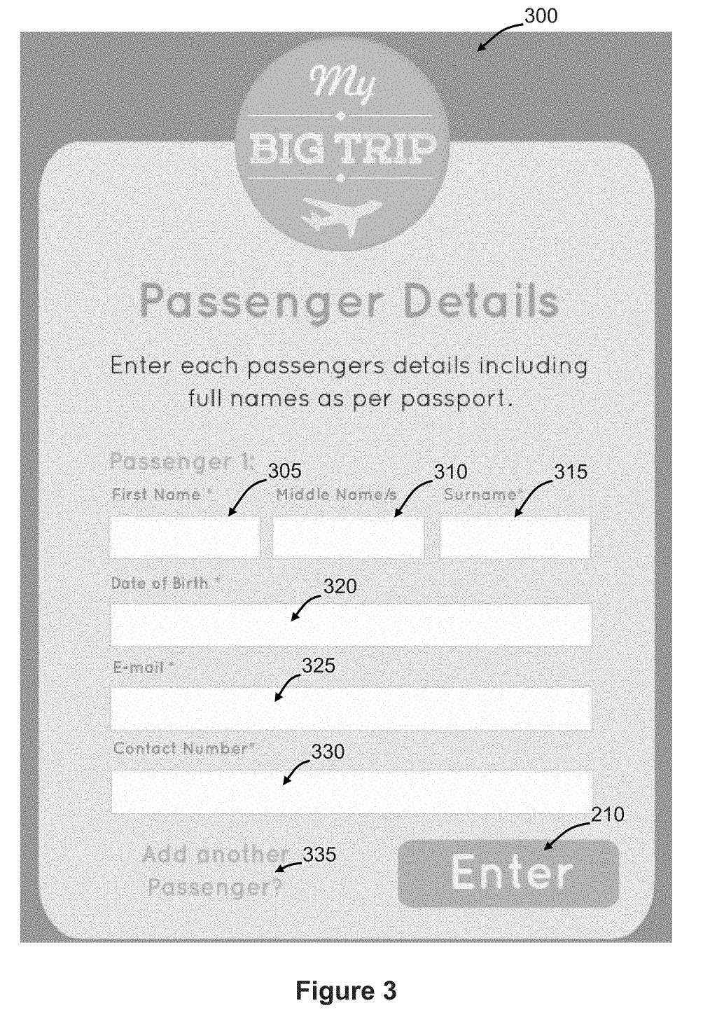

FIG. 3 illustrates a screenshot 300 of a passenger details screen, according to an embodiment of the present invention. The passenger details screen enables the user to enter his or her details, together with those travelling with him or her.

The passenger details screen includes name entry fields in the form of a first name entry field 305, a middle name entry field 310 and a surname entry field 315, enabling the user to enter a full name of the first passenger. The passenger details screen further includes a date of birth field 320, an email field 325, and a contact number field 330, enabling the user to enter date of birth, email and contact number details of the first passenger.

An “add another passenger” button 335 enables the user to enter multiple passengers to the trip. The “add another passenger” button 335 may be selected as many times as required to enter details of all passengers.

Once the user has finished entering details of the passengers, the “enter” button 210 may be selected to navigate to the trip details screen.

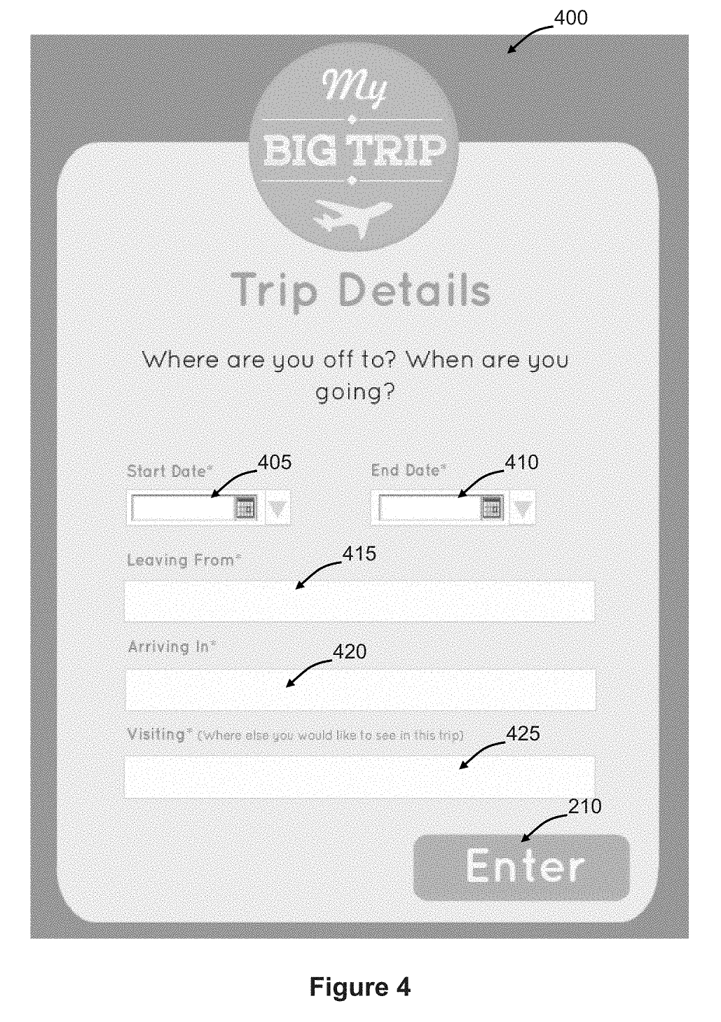

FIG. 4 illustrates a screenshot 400 of a trip details screen of the system 100, according to an embodiment of the present invention. The trip details screen enables the user to select start and end dates of the trip, as well as destinations of the trip.

The trip details screen includes a start date element 405 and an end date element 410. The start and end date elements 405, 410 enable the user to enter dates defining when the trip starts and finishes. The start and end date elements 405, 410 may link to a calendar, such that the user is able to select a day on a calendar, rather than enter the data manually.

The user is then able to enter travel details in the form of a departure city, an arrival city and one or more visiting cities in a departure city element 415, an arrival city element 420 and a visiting cities element 425. The arrival city is generally a first destination on the trip, and the visiting cities countries) are other places to be visited on the trip.

As an illustrative example, the user may enter into the trip details screen that the trip will start 2 Feb. 2016, end 28 Feb. 2016, leave from Brisbane, arrive in London, and visiting cities in Italy, France, Switzerland, Germany.

Once the user has finished entering details of the trip, the “enter” button 210 may be selected to navigate to the trip creation screen.

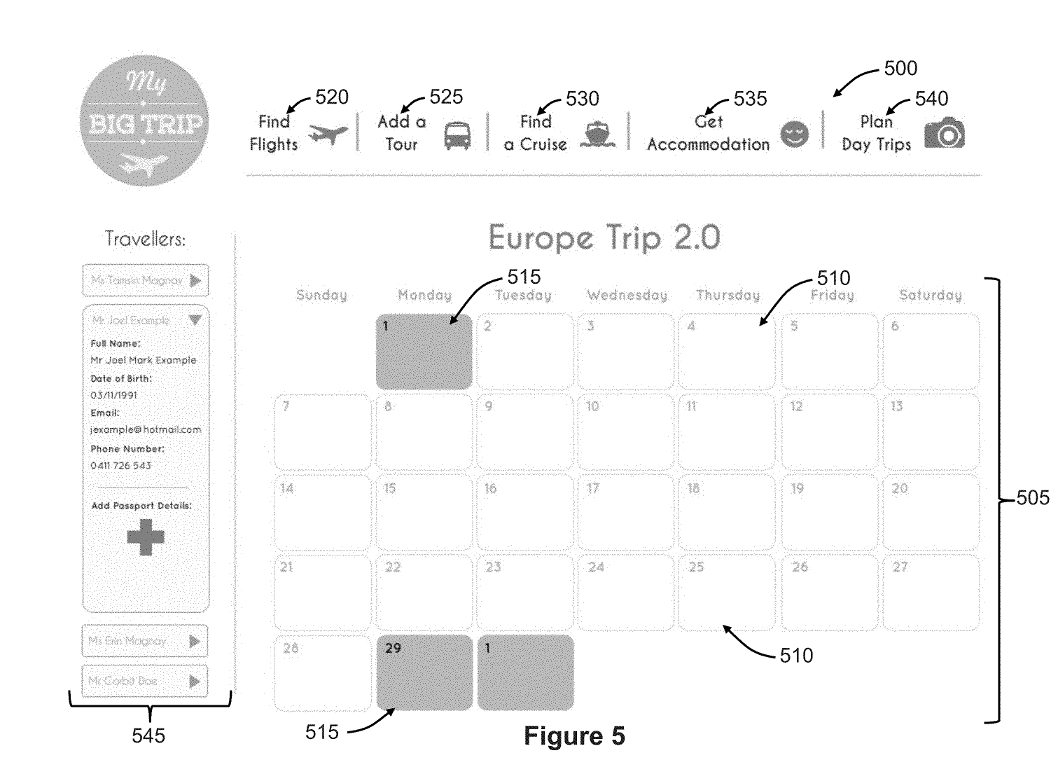

FIG. 5 illustrates a screenshot 500 of a trip creation screen, according to an embodiment of the present invention.

The trip creation screen includes a calendar element 505, on which the trip is created. In particular, the user adds elements to the calendar element 505 to create the trip, and the server 105 filters which components can be added to the trip based upon other elements already in the calendar.

Initially, the calendar includes a plurality of free days 510, which show when trip components may be booked, and unavailable days 515, which show when trip components cannot be booked. As components are added to the calendar, the free days 510 become booked, as outlined below.

The trip creation screen includes a find flights button 520, an add tour button 525, a find cruise button 530, a get accommodation button 535 and a plan day trips button 540. These buttons 520-540 enables the user to create the trip by adding flights, tours, cruises, accommodation and/or tours, respectively.

Finally, the trip creation screen includes a traveller's detail element 545, which summaries details of each of the travellers, such as name, date of birth and the like.

If the user selects the add tour element 525, the server 105 generates a list of proposed tours according to the date criteria, the destination, as well as demographics of the travellers, such as age. For example, the server may propose tours suited to people of similar age to the travellers, and match the places the travellers want to visit on the trip.

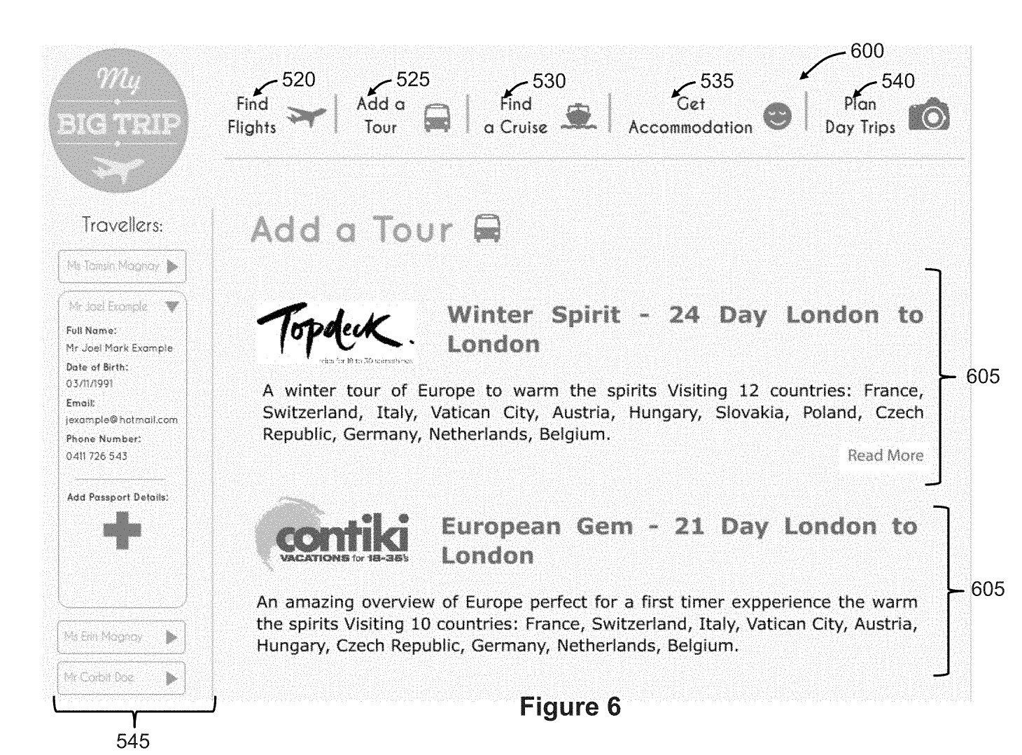

FIG. 6 illustrates a screenshot 600 of a tour selection screen of the system 100, according to an embodiment of the present invention.

The tour selection screen includes a plurality of tour elements 605, each of which is selectable by the user. The tour elements correspond to tours that match the date criteria, the destination, and demographics of the travellers.

Each of the tour elements 605 includes a logo, a title, and a short description, to provide the user with an overview over what the tour relates. The user may then select a tour element 605 to get further detail on the tour, such as price.

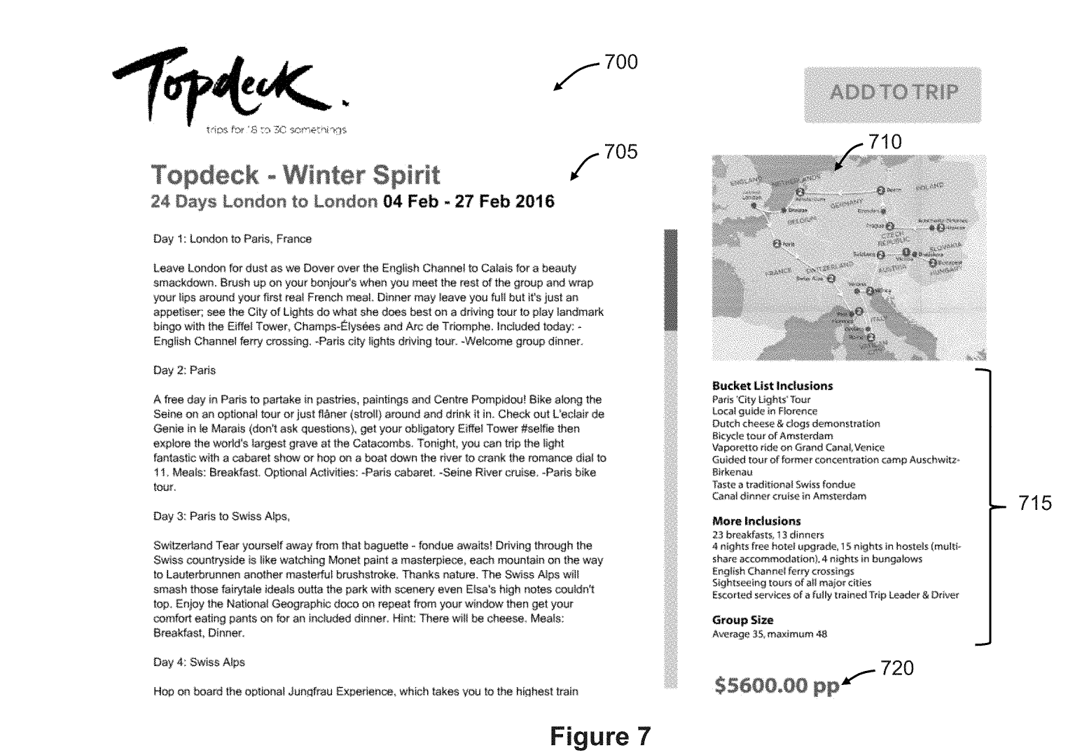

FIG. 7 illustrates a screenshot 700 of a tour detail screen of the system 100, according to an embodiment of the present invention.

The tour detail screen includes a tour detail element 705, providing detail of the tour, such as a day to day itinerary, a map element 710, illustrating the tour graphically on a map, a tour summary element 715, summarising details of the tour, including inclusions and group size, and a tour price element 720, providing a price of the tour.

The tour may be added to the calendar through selection of an “add to trip” button 725. Once the tour is added to the calendar, the calendar element 505 is updated to graphically illustrate this.

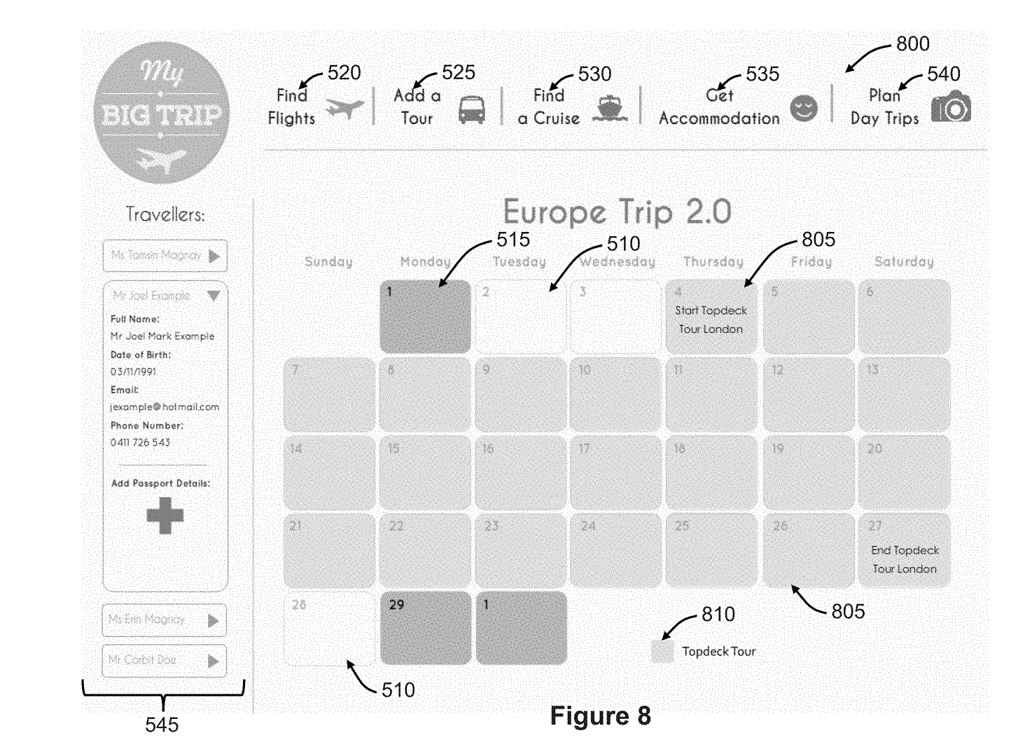

FIG. 8 illustrates a further screenshot 800 of the trip creation screen, according to an embodiment of the present invention.

The map element 505 highlights each day of the tour as tour days 805, which are similar to the unavailable days 515. However, in contrast to the unavailable days 515, the tour days may be used for booking other components of the trip, if compatible with the tour. For example, if a tour is exclusive of accommodation on one or more tour days, accommodation may be booked on those tour days 805.

Furthermore, the trip creation screen includes a legend 810, which enables the user to differentiate between multiple tours on the calendar. In such case, the multiple tours (and thus the tour days 805) may be colour coded according to tour, or shaded or rendered accordingly.

As the tour days are highlighted, it simplifies the process for the user of organising other components of the trip.

Upon selection of the find flights button 520, a flight details screen is provided.

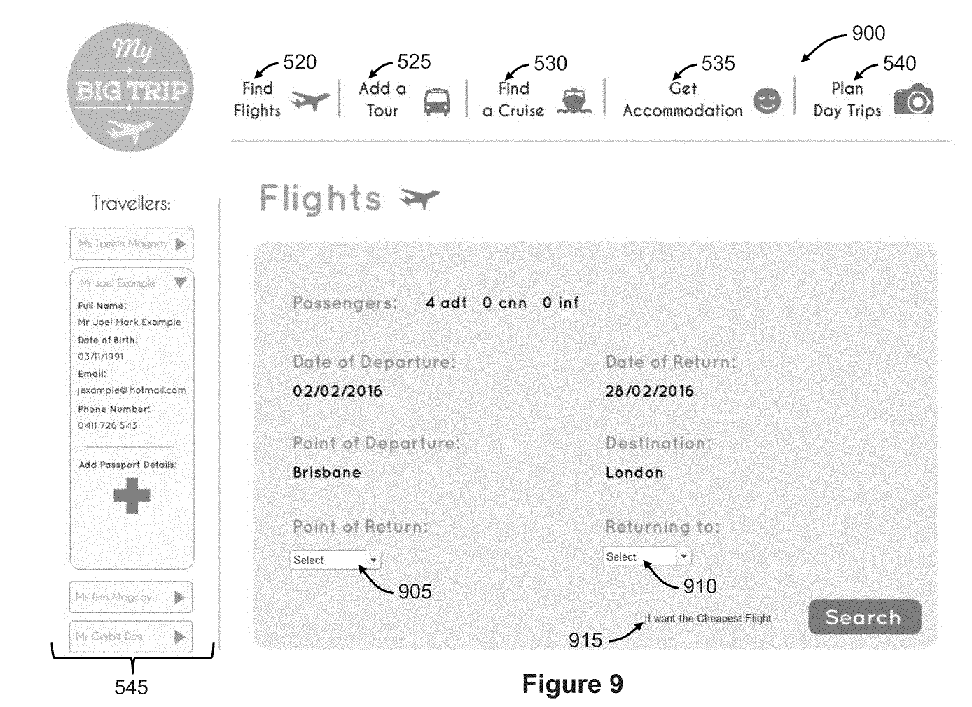

FIG. 9 illustrates a screenshot 900 of a flight details screen, according to an embodiment of the present invention.

The flight details screen includes details of the number of passengers and type (e.g. 4 adults, 0 children and 0 infants), departure and return dates, as well as departure and arrival cities, which are pre-filled using data previously entered.

The flight details screen further includes a point of return element 905 and a returning to element 910, which enables the user to enter different returning from and to cities. This is particularly useful when the passengers shall fly into one city (e.g. London) and out of another city (e.g. Rome).

The flight details screen further includes a cheapest flight checkbox 915, which, when selected, prioritises cheaper flights. This is particularly advantageous if the passengers are somewhat flexible with their travel times, and prefer low cost flights.

Once the user is ready to search for flights, he or she may click on a search button 920, upon which a flight results screen is displayed.

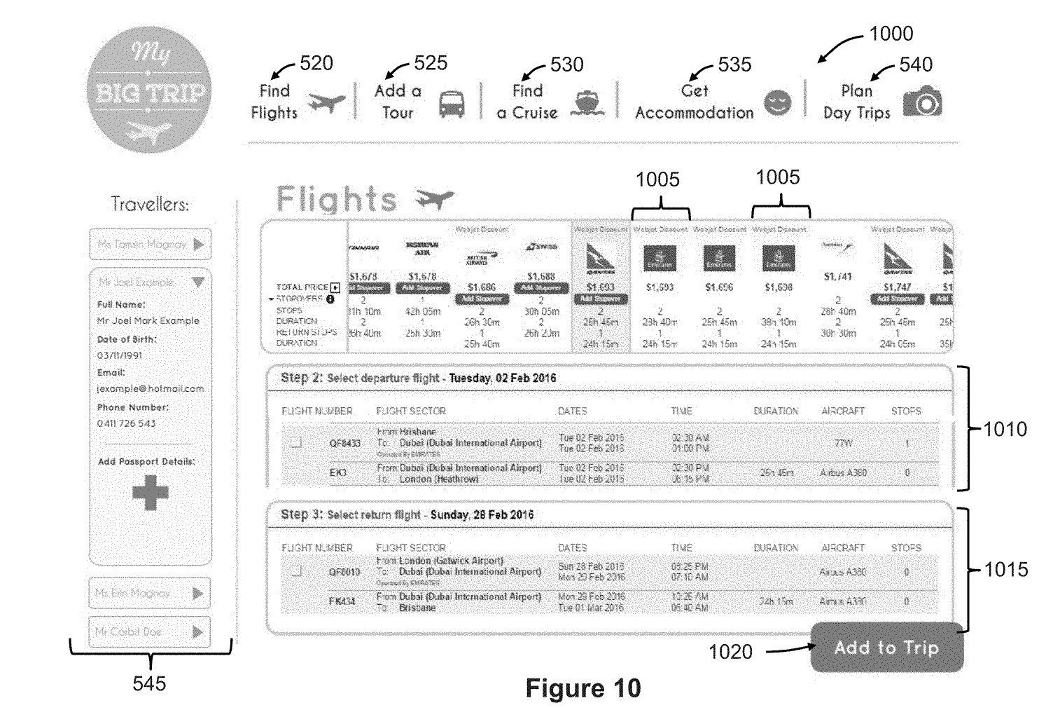

FIG. 10 illustrates a screenshot 1000 of a flights results screen, according to an embodiment of the present invention. The flight results screen includes a plurality of flight elements 1005, each associated with a airline, a price, a duration and a number of stops.

Upon selection of a flight element 1005, corresponding departure and return flight detail elements 1010, 1015 are illustrated.

The user may review and ultimately select departure and return flight detail elements 1010, 1015 to make a booking. Once the user has selected these flights, an “add to trip” button 1020 may be selected to add the flight details to the calendar.

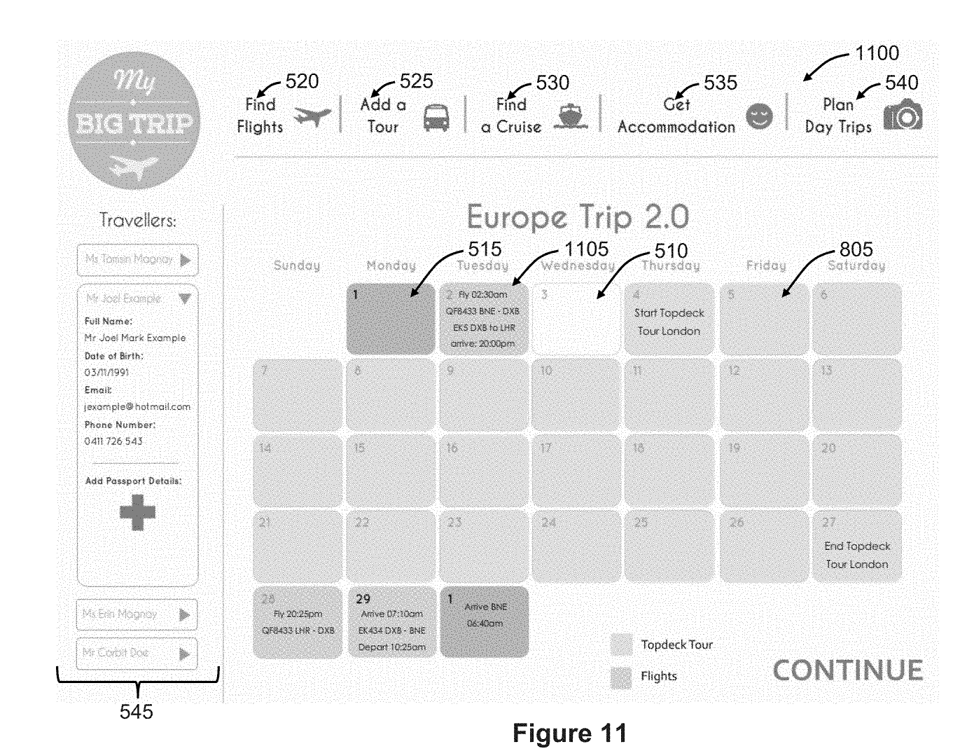

FIG. 11 illustrates a further screenshot 1100 of the trip creation screen, according to an embodiment of the present invention. The map element 505 highlights each day on the selected flights as flight days 1105, which are similar to the tour days 805, but illustrate time spent on the selected flights, rather than time spent on a tour.

When the user no longer wishes to add any further components to the trip, a continue button 1110 may be selected. Upon selection of the continue button 1110, a trip summary screen is shown.

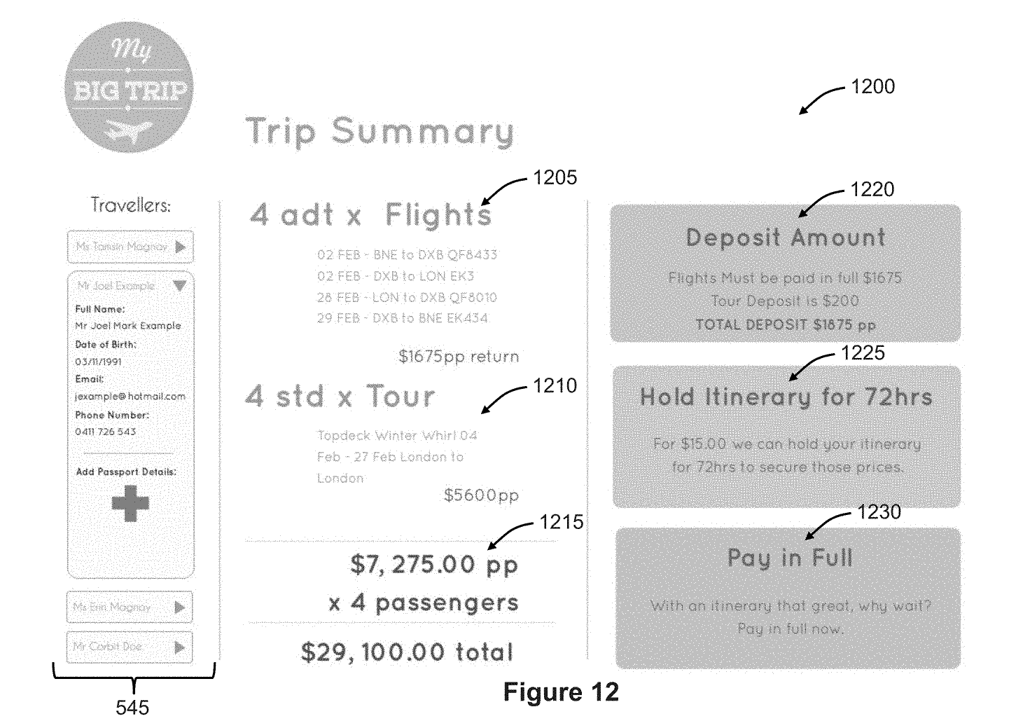

FIG. 12 illustrates a screenshot 1200 of a trip summary screen, according to an embodiment of the present invention.

The summary screen includes a flight details element 1205, illustrating details of the selected flights, and a tour details element 1210, illustrating details of the selected tour. A cost element 1215 illustrates both the cost per person, and the total cost of the trip (i.e. flights and tours).

The summary screen further includes a deposit element 1220, a hold itinerary element 1225, and a pay in full element 1230. The deposit element 1220 enables the user to pay a deposit for the trip, and includes a minimum deposit amount. The hold itinerary element 1225 enables the user to hold the itinerary for 72 hours for a $15 fee, and the pay in full element 1230 enables the user to pay in full directly.

Once the user has paid the deposit, held the itinerary, or paid in full, the server 105 confirms the booking with the associated component providers, such as the flight provider 125 and tour operator 130. Similarly, if a hotel, cruise or ground transport were also provided in the itinerary, the server 105 would confirm the booking of these with the hotel 135, cruise company 140 or ground transport provider 145 as well.

According to certain embodiments, the itinerary is sent to a travel agent, for final review and booking. Upon completion of the booking, an email may be sent to the user, and the email may or may not identify the travel agent.

In some cases, the travel agent is identified, and the user is able to visit the travel agent to discuss the booking and make final changes. As such, much of the travel agent's time is saved as only certain aspects of the trip need be discussed and changed, leaving more time to focus on the areas of the holiday needing attention by the travel agent

According to certain embodiments, the currency used by the system is determined according to a location of the user. In some cases the location is determined by the IP address of the user, and in other cases, a positioning system of the user device may be activated, such as a GSP.

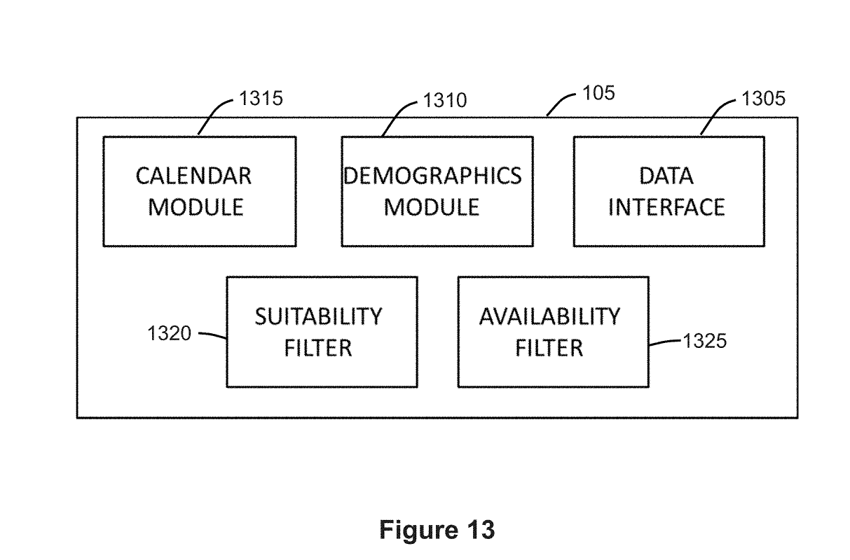

FIG. 13 illustrates a schematic 1300 of the server 105, according to an embodiment of the present invention.

The server 105 includes a data interface 1305, on which the graphical user interface is provided to the user, and on which data is received from the user. The graphical user interface may be similar to that described above with reference to FIGS. 2-12, and enables the user to enter details of the travellers, and generate a trip using a calendar as outlined below.

Based upon the details of the travellers, such as date-of-birth, a demographics module 1310 profiles the travellers. Examples of such data used by the demographics module 1310 includes age, group composition (adults+children=family), as well as other types of data, such as past travel and the like.

The server 105 further includes a calendar module 1315, for generating a personalised calendar for the trip, such that components of the trip can be chosen by the user added to the calendar to define the trip. The calendar module 1315 simplifies the process of choosing components, as it enables the components to be graphically displayed with reference to a calendar, which enables the user to clearly see how each component of the trip is positioned on the calendar.

In particular, trip components are proposed to the user, upon which they may be entered into the calendar. The trip components may be simply selected, upon which they are inserted into the calendar (if the dates are set), or dragged and dropped onto desired days (if multiple date options are available). The trip components are proposed to the user based upon a suitability, determined by a suitability filter 1320, and an availability, determined by an availability filter 1325.

The suitability filter 1320 may either determine trip components that are suitable to the travellers based upon demographics, and promote these, or determine trip components that are unsuitable to the travellers, and remove these from selection. As such, components, such as (potentially) inappropriate tours, may be filtered, such that the proposed components are most relevant to the user.

As an illustrative example, a group of 2.0 year olds may be proposed tours that are age appropriate, such as young travel tours, such as Topdeck and Contiki tours, and not tours that are not age appropriate, such as APT and SCENIC tours.

The availability filter 1325 determines trip components that are suitable, based upon other components of the trip and/or user input. For example, if a tour is not available on days of the trip, or is in direct conflict with another component (such as another tour), that tour is not available for booking, and is thus not shown to the user.

The availability filter may allow certain components to overlap. For example, each day of a component may be associated with a plurality of flags indicating a compatibility with other elements. As an illustrative example, a tour may include accommodation all evenings, bar the final day of the tour, and as such, may be marked as incompatible with accommodation all days bar the final day.

The systems described above may be used directly by a traveller, or by a travel agent (e.g. in store). For example, a traveller may use the systems to plan and book a trip in its entirety. Similarly, a travel agent may use the system to document the planning of a trip in store, so that he or she is able to propose the most relevant (and available) components of the trip. In yet a further alternative, a traveller may use the system to create an initial trip (itinerary), which is then reviewed and booked by a travel agent.

According to certain embodiments, the systems described above may also be used to make changes to a trip during the trip. For example, a traveller may use the systems to extend or shorten their itinerary whilst travelling, and be given instant costs on how much it is to change.

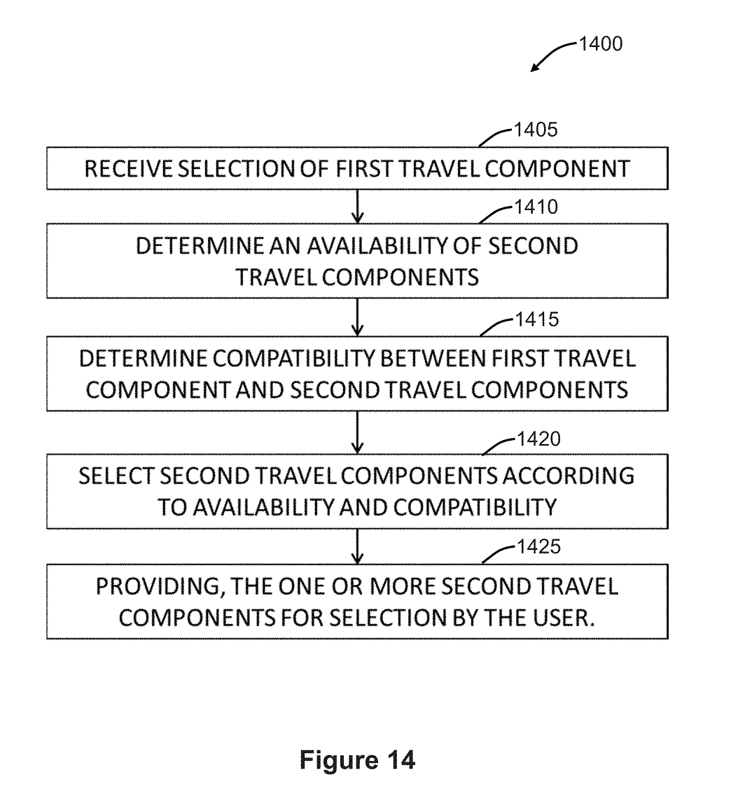

FIG. 14 illustrates a travel booking method 1400, according to an embodiment of the present invention. The travel booking method 1400 may be performed by the system 100, described above.

At step 1405, a selection of a first travel component is received. The first travel component may comprise a tour, a flight, a cruise, or any other suitable travel component.

At step 1410, an availability of a plurality of second travel components are determined. In this regard, determining availability may include, for example, determining whether a component is booked out (sold out), or whether a component is available within a particular price range.

At step 1415, compatibility between the first travel component and each of the second travel components is determined. Determining compatibility may comprise determining whether time periods of the first and second travel components overlap, or determining any other incompatibility between the travel components.

At step 1420, one or more of the plurality of second travel components are selected according to the availability and the compatibility. According to certain embodiments, demographics of travellers may also be used to select the travel components, or rank the travel components based upon a suitability with reference to the traveller(s).

At step 1425, the one or more selected second travel components are provided to the user for selection by the user. The one or more selected second travel components may be provided in a graphical user interface for selection by the user.

Steps 1410-1425 may be repeated for third, fourth, fifth, etc., travel components such that a complete travel itinerary (e.g. relating to a package holiday) can be generated. The method may also include generating a PDF itinerary, which can be printed and used by the traveller(s).

While the above systems and methods have been described with reference to a web page, the skilled addressee will readily appreciate that a standalone software application (or app) may be used.

According to certain embodiments, different user interfaces may be provided depending on whether the system is interacted with from within a travel agent, or outside of a travel agent. In particular, a travel agent may provide tablet computers to customers to assist them in selecting components of a holiday, while retaining the booking of the holiday by the travel agent. Costs of holiday components may vary depending on whether the user is at a travel agent or not, to allow for commission to the travel agent.

According to certain embodiments, a travel agent and a customer may work simultaneously on an itinerary. This enables the travel agent to make proposals, which can be viewed by the customer in the context of the itinerary, or vice versa. As such, instead of providing brochures to the customer, the travel agent may provide a tablet computer, through which the user is able to read about tours proposed by the travel agent.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for booking a package holiday comprising a plurality of holiday components, the method comprising:
receiving a selection of a first holiday component;
selecting one or more of a plurality of second holiday components according to an availability of the second holiday components and a compatibility with the first holiday component; and
providing, the one or more second holiday components for selection by the user.

2. The method of claim 1, wherein the first holiday component relates to a different category of holiday component to the second holiday components.

3. The method of claim 2, wherein the categories include one or more of: flights, insurance, car hire, accommodation, cruises, river cruises, coach tours, day trips, transfers, visa's and currency exchange.

4. The method of claim 1, further comprising determining an availability of each of a plurality of second holiday components.

5. The method of claim 1, wherein the first holiday component is associated with a first time period, and the second holiday component is associated with a second time period, and determining a compatibility with the first holiday component comprises determining that the first and second time periods do not overlap.

6. The method of claim 1, wherein the one or more second holiday components are selected in part according to demographics of one or more travelers.

7. The method of claim 6, wherein the one or more second holiday components are selected in part according to demographics of a group of travelers.

8. The method of claim 7, wherein the demographics include a group composition.

9. The method of claim 1, further comprising: receiving a selection of cities or countries, where the holiday components are selected in part according to the selected cities or countries.

10. The method of claim 1, further comprising: receiving start and end times of the package holiday; and determining an availability of the plurality of second holiday components at least in part according to the start and end times.

11. The method of claim 1, further comprising, entering, into a digital calendar, details of the first holiday component, wherein the second holiday components may be selected with reference to the calendar, and subsequently entered into the digital calendar.

12. The method of claim 11, wherein the digital calendar is displayed to the user and the first and second holiday components are graphically distinguishable in the calendar.

13. The method of claim 11, wherein the second holiday components are selected by dragging the component onto the calendar with a drag and drop system.

14. The method of claim 13, wherein the calendar is configured to prevent the second holiday components from being dragged onto non-available positions.

15. The method of claim 11, wherein the calendar is defined in memory, where each day is associated with an attribute indicating an availability of that day.

16. The method of claim 15, wherein the attribute defines a compatibility with other holiday components.

17. The method of claim 15, wherein a plurality of attributes are associated with each day.

18. The method of claim 1, comprising providing a graphical user interface to the user, the graphical using interface including a calendar.

19. The method of claim 1, further comprising illustrating at least one of the second holiday components according to a map.

20. A travel booking system, for booking travel comprising a plurality of travel components, the system comprising:
a selection module, for selecting one or more of a plurality of second travel components according to an availability of the second travel components and a compatibility with a first travel component; and
a data interface, for receiving a selection of a first travel component, and providing the one or more second travel components for selection by the user.
